(19) United States
(12) Patent Application Publication
(10) Pub. No.: US 2001/0006961 A1
(43) Pub. Date: Jul. 5, 2001

(54) METHOD FOR IMPROVING FRUIT YIELDS FROM BANANA PLANTS

(76) Inventors: JORGE GONZALES, WESTLAKE VILLAGE, CA (US); JORGE CEPEDA, MIAMI, FL (US); JUAN BOCANEGRA, MIAMI, FL (US)

Correspondence Address: MICHELE C. BOSCH, ESQ. L.L.P., FINNEGAN, HENDERSON, FARABOW, GARRETT & DUNNER,, 1300 I STREET , N.W., WASHINGTON, DC, 20005-3315, US

(21) Appl. No.: 09/288,627

(22) Filed: Apr. 9, 1999

Related U.S. Application Data
(63) Continuation of application No. 08/764,936, filed on Dec. 13, 1996.

(30) Foreign Application Priority Data
Sep. 5, 1995 (FR) 95 10575

(51) Int. Cl. A01N 57/18

(52) U.S. Cl. 514/141

(57) ABSTRACT

Method for improving the fruit yields from banana plants, characterized in that an effective and non-phytotoxic dose of a compound A, chosen from:

salts of a monoalkyl phosphonate and of a mono-, di- or trivalent metal cation, such as fosetyl-Al, or

phosphorous acid and its alkali metal or alkaline-earth metal salts, is applied on the banana plants.

The present invention relates to a method for improving fruit yields from banana plants.

Fruit yields from banana plants currently reach 40 tonnes per hectare and up to 60 tonnes per hectare under the best conditions. These yields can, however, be limited by the presence of diseases, such as Fusarium disease or Cercospora disease, but also by other factors.

It is therefore always desirable to increase these fruit yields, for readily understandable profitability reasons, independently, in particular, of the diseases by which banana plants may be attacked or by which it may be supposed that they will be attacked.

It is thus particularly advantageous to increase the average weight per plant of the bunches of bananas produced by a banana plantation.

An increase in this average weight, even a small increase, corresponds, due to the very high production per hectare, to an additional harvest of fruits, the quantitative importance of which is particularly appreciable.

One aim of the present invention is therefore to increase the fruit yields of banana plantations.

Another aim of the present invention is to increase the fruit yields of banana plantations, independently of the diseases by which these banana plants may be attacked or by which it may be supposed that they will be attacked.

Another aim of the present invention is to increase the average weight per plant of the bunches of bananas produced by a banana plantation, independently of the diseases by which these banana plants may be attacked or by which it may be supposed that they will be attacked.

It has been found that these aims could be achieved, in all or in part, by means of the treatment method according to the invention.

The present invention accordingly provides a method for improving the fruit yields from banana plants, characterized in that an effective and non-phytotoxic dose of a compound A, chosen from:

salts of a monoalkyl phosphonate with a mono-, di- or trivalent metal cation, such as fosetyl-Al, or

phosphorous acid and its alkali metal or alkaline-earth metal salts, is applied on the banana plants.

Fosetyl-Al is aluminium tris(O-ethyl phosphonate), described in “The Pesticide Manual”, 9th edition, by Charles R. Worthing and Raymond J. Hance, published by the British Crop Protection Council.

The dose of compound A applied is capable of varying within wide limits according to the weather conditions, the growth conditions and the frequency of the treatments carried out. For convenience, this dose is expressed as equivalent weight of phosphorous acid, of formula H₃PO₃, applied per hectare. This dose is generally between 0.7 and 17 kg/ha and preferably between 1.5 and 10.5 kg/ha. The calculation, from this dose, of the dose of a specific compound A is conveniently carried out by taking into account the molar mass of the said compound and that of phosphorous acid. In the case where the specific compound A is a salt of a monoalkyl phosphonate and of a di- or trivalent metal cation, the valency number of the corresponding cation should also be taken into consideration.

According to an advantageous embodiment of the invention, the compound A applied is fosetyl-Al. In this case, the dose of compound A, expressed as weight of fosetyl-Al applied per hectare, is between 1 and 25 kg/ha and preferably between 2 and 15 kg/ha.

According to a preferred method of the invention, the banana plants on which the compound A is applied are healthy banana plants. “Healthy banana plants” is understood to mean banana plants exhibiting no symptom characteristic of diseases or parasites known to affect them, such as, but not exclusively, Fusarium disease or Cercospora disease. The healthy banana plants can in particular be banana plants forming the subject of a conventional preventive treatment against fungal diseases, the said treatment being known to have no effect on the fruit yield.

The compound A can be applied by spraying onto the aerial parts of the banana plants, for example by any means known per se, such as by a sprayer or alternatively by the aerial route. In this case, the dose of compound A applied, expressed as equivalent weight of phosphorous acid, is generally between 0.7 and 7 kg/ha and preferably between 1.5 and 3.5 kg/ha. This treatment can advantageously be repeated 3 times during the year following the first treatment.

When, according to a preferred embodiment of the present invention, the compound A is fosetyl-Al, the dose of compound A is between 1 and 10 kg/ha and preferably between 2 and 5 kg/ha.

According to another preferred embodiment of the invention, the compound A is applied by injection into the pseudostem, for example by any means known per se. Injection can be carried out into the pseudostem of the banana plant which is growing and which will give fruits from the next harvest. Injection can also be carried out, cumulatively, into the section of the pseudostem of the banana plants. Pseudostem of the banana plants is understood to denote the stem of these plants, which is non-ligneous in nature. Section of the pseudostem is understood to mean the section obtained by cutting the above pseudostem, which is growing, at a certain height above the ground (generally of between 0.5 to 2.5 m) during the last banana harvest. Application of the compound A can be carried out, for example, by injection or by simply pouring a treatment liquid comprising A into a cavity, of the order of 5 cm in depth, made in this section. This application technique makes it possible to reduce the frequency of the treatment by carrying out one single treatment during the period separating the production of 2 crops of bananas by the same plant. It also makes it possible to carry out this treatment at the time of harvesting the bunch of bananas on the plant. This results in an appreciable saving in time for the farmers.

In other words, it should be understood, within the meaning of the present invention, that a conventional technique for growing bananas comprises planting banana plants as mother plants and causing them to grow over large areas or plantations. Each mother plant, thus situated, has a series (for example 1 to 5, generally 1 to 3) of shoots, otherwise known as daughter plants, the growth of which takes place from the bulb (that is to say, the base of the pseudostem) of the mother plant. Consequently, it is easily understood that the mother and daughter plants share a common root system. At an appropriate moment before harvesting the fruit from the mother plant, all the daughter plants are removed, with the exception of a single one per mother plant, this retained daughter plant being that judged by the farmer as having the best chances of survival. Such a practice allows the new generation of banana plants to be easily and quickly produced. Removal of the undesirable daughter plants is possible after harvesting the mother plants but it is preferable to carry it out before, for agronomical reasons.

The bananas are harvested simply by cutting off the bunches of fruits. After this, the mother trees are cut back in order to remove the leaf canopy. The retained pseudostems have a height which varies generally from 0.5 to 2.5 m, the cutting thus carried out leaving a section, as defined above, exposed to the open air. Such a practice facilitates growth of the daughter plants. The pseudostem of the mother plant is then left as is until withering or it is cut back again in stages until only the pseudostem of the daughter plant alone remains.

The compound A is, in this embodiment of the invention, injected or applied in the section of the pseudostem of the mother plant according to the description given above. This treatment, via the section of the pseudostem of the mother plant, has the advantage of improving the yield of bananas from the daughter plant.

According to a particularly preferred embodiment of the invention, an additional dose of compound A is injected into the pseudostem of the daughter plant, generally at the flowering stage.

In the case of this application by injection, the dose of compound A applied, expressed as equivalent weight of phosphorous acid, is usually between 1.5 and 17 kg/ha and preferably between 2.5 and 10.5 kg/ha.

In the latter case, when the compound A is fosetyl-Al, the dose of compound A is between 2 and 25 kg/ha and preferably between 4 and 15 kg/ha.

For its practical application to banana plants, the compound A is used in the form of a banana yield-enhancing composition which is also a subject of the invention.

The banana yield-enhancing composition which is a subject of the invention usually comprises from 0.5 to 95% of compound A in association with a vehicle which is acceptable in agriculture.

It can additionally comprise all the usual additives or adjuvants of plant-protection compositions, especially surface-active agents, adhesion agents and flow-improving agents.

In the present account, the term “vehicle” denotes a natural or synthetic, organic or inorganic material with which the active materials are combined to facilitate their application on the plant. This vehicle is thus generally inert and it must be acceptable in agriculture, especially on the treated plant. The vehicle can be solid (eg. clays, natural or synthetic silicates, silica, resins, waxes, solid fertilizers) or liquid (eg. water, alcohols, ketones, petroleum fractions, aromatic or paraffinic hydrocarbons, chlorinated hydrocarbons, liquefied gases).

The surface-active agent can be an emulsifying, dispersing or wetting agent of ionic or nonionic type. There may be mentioned, for example, salts of polyacrylic acids, salts of lignosulphonic acids, salts of phenolsulphonic or naphthalenesulphonic acids, polycondensates of ethylene oxide with fatty alcohols or with fatty acids or with fatty amines, substituted phenols (especially alkylphenols or arylphenols), salts of esters of sulphosuccinic acids, taurine derivatives (especially alkyltaurates) or phosphoric esters of polyoxyethylenated phenols or alcohols. The presence of at least one surface-active agent is desirable to promote dispersion of the active materials in water and their ready application on the plants.

This composition can also contain any kind of other ingredients such as, for example, protective colloids, adhesives, thickening agents, thixotropic agents, penetrating agents, stabilizing agents, sequestering agents, pigments, dyes or polymers.

More generally, the composition which can be used in the process according to the invention and/or subject of the invention can include all the solid or liquid additives corresponding to the usual techniques for the formulation of plant-protection products.

This composition can be in the solid, gel or liquid form and, in the latter case, in the form of solutions or suspensions. Liquid compositions are preferred, due both to their convenience of use and to their simplicity of manufacture.

There may be mentioned, as forms of solid compositions, powders for dusting or dispersion (with an active compounds content which can range up to 100%), wettable powders and granules for dry spreading, as well as dispersible or soluble granules.

Wettable powders (or powders to be sprayed), as well as dispersible granules, generally contain 20 to 95% of active materials and, in addition to the solid vehicle, from 0 to 5% of a wetting agent, from 3 to 10% of a dispersing agent and, when necessary, from 0 to 10% of one or more stabilizing agents and/or other additives, such as pigments, dyes, penetrating agents, adhesives, or anticlumping agents. It is well understood that some of these compositions, such as wettable powders or dispersible granules, are intended to constitute liquid compositions at the time of application.

There may be mentioned, as forms of liquid compositions, solutions, in particular water-soluble concentrates, suspension concentrates or pastes.

The soluble concentrates most often comprise 10 to 80% of active material, the solutions ready for application containing, for their part, 0.01 to 20% of active material. As has already been said, aqueous dispersions, for example the compositions obtained by diluting a wettable powder according to the invention with water, come within the general scope of the present invention.

The suspension concentrates, also applicable by spraying, are a stable fluid product, which does not thicken or form a sediment after storage, and they generally contain from 10 to 75% of active materials, from 0.5 to 15% of surface-active agents, from 0.1 to 10% of thixotropic agents and from 0 to 10% of suitable additives, such as pigments, dyes, antifoaming agents, corrosion inhibitors, stabilizing agents, penetrating agents and adhesives and, as vehicle, water or an organic liquid in which the active materials are insoluble or nearly insoluble: certain organic solid materials or inorganic salts can be dissolved in the vehicle to aid in preventing sedimentation or as antigels for water.

The compositions described above may be prepared according to processes known per se.

Thus, to obtain powders to be sprayed or wettable powders, the active materials are intimately mixed, in suitable mixers, with the additional substances and the mixture is milled with mills or other grinders. Powders to be sprayed are thereby obtained with advantageous wettability and suspensibility; they can be suspended in water at any desired concentration and these suspensions can be used very advantageously, in particular for application on the aerial parts of the plants.

Pastes or suspension concentrates can be produced in place of wettable powders. The conditions and modes of production and use of these pastes are similar to those of wettable powders or powders to be sprayed, part of the milling operation necessary simply being carried out in a liquid medium.

The dispersible granules are generally prepared by agglomeration or extrusion or compacting, in suitable granulation systems, of compositions of wettable powder type. The granules for dry spreading are generally obtained by impregnating a granulated vehicle with a solution or an emulsion of the active materials.

The following examples are given purely by way of illustration and without implied limitation of the advantageous properties of the process and of the composition according to the invention.

Example 1: In viva test of a composition comprising fosetyl-Al on a banana plantation:

The test is carried out on a plantation of banana plants which have reached a stage of regular fruit production. This plantation is furthermore treated periodically throughout the duration of the test by means of a conventional protective treatment against various fungal diseases, as well as against harmful insects and nematodes, which treatment is known to have no effect of the type of those observed below with fosetyl-Al.

The duration of the test is 2 years.

At the beginning of the first year, treatment with fosetyl-Al is carried out. For this, use is made of a wettable powder formulation of fosetyl-Al diluted in water before use, which is applied by means of a knapsack sprayer. The application dose is 6.4 kg of fosetyl-Al per hectare. This application of fosetyl-Al is repeated every 3 months throughout the duration of the test.

The average weight of a bunch of bananas harvested per plant is measured. The mean value of this weight, during the 2nd year of the test, is equal to 39.8 kg.

In comparison, a control test was carried out, in which there was no application of fosetyl-Al, the protocol otherwise being identical. This test gave 38.4 kg as the average value of the weight of a bunch of bananas harvested per plant, measured under the same conditions as above.

Such a difference, amounting to a relative value of 5%, corresponds to a considerable additional amount of fruit, of the order of 2 tonnes in the case where the yield of the banana plantation is 40 tonnes/hectare of bananas.

Example 2: In vivo test of a composition comprising fosetyl-Al on a banana plantation:

Example 1 is repeated, a plantation situated on a soil of different nature being treated and the treatment being carried out with an aeroplane. The fosetyl-Al doses applied are shown in the table below, along with the average banana bunch weights obtained.

| | | Average weight of a |
|---|---|---|
| | | bunch (kg) |
| Fosetyl-A1 dose | 3.2 | 38.9 |
| (kg/ha) | 6.4 | 39.7 |
| Control test | | 37.4 |

The differences observed also correspond to a very appreciable improvement in the fruit yield.

Example 3: In vivo test of the application of a composition comprising fosetyl-Al by injection into the growing pseudostem:

The test is carried out on a plantation of banana plants which have reached a stage of regular fruit production. This plantation is furthermore treated periodically throughout the duration of the test by means of a conventional preventive treatment against various fungal diseases, as well as against harmful insects and nematodes, which treatment is known to have no effect of the type of those observed below with fosetyl-Al.

Fosetyl-Al is injected into the pseudostem of the growing banana plants, in the proportion of 6 kg/ha (i.e. 3 g of fosetyl-Al per plant), 1 month before flowering.

The fruits are harvested 4 months later. The average weight of the bunch of bananas is 31.4 kg. The average weight of a bunch of bananas corresponding to the control test (untreated banana plants) is 28.3 kg.

1. Method for improving the fruit yields from banana plants, characterized in that an effective and non-phytotoxic dose of a compound A, chosen from:
salts of a monoalkyl phosphonate with a mono-, di- or trivalent metal cation, such as fosetyl-Al, or
phosphorous acid and its alkali metal or alkaline-earth metal salts, is applied on the banana plants.

2. Method according to claim 1, characterized in that the dose of compound A, expressed as equivalent weight of phosphorous acid, is between 0.7 and 17 kg/ha and preferably between 1.5 and 10.5 kg/ha.

3. Method according to claim 1 or 2, characterized in that the compound A is fosetyl-Al.

4. Method according to claim 3, characterized in that the dose of fosetyl-Al is between 1 and 25 kg/ha and preferably between 2 and 15 kg/ha.

5. Method according to one of claims 1 to 4, characterized in that the compound A is applied on healthy banana plants.

6. Method according to any one of claims 1 to 5, characterized in that the compound A is applied by spraying onto the aerial parts of banana plants at a dose, expressed as equivalent weight of phosphorous acid, of between 0.7 and 7 kg/ha and preferably between 1.5 and 3.5 kg/ha.

7. Method according to claim 6, characterized in that the compound A is fosetyl-Al applied at a dose of between 1 and 10 kg/ha and preferably between 2 and 5 kg/ha.

8. Method according to any one of claims 1 to 5, characterized in that the compound A is applied, preferably by injection into the pseudostem of the banana plants at a dose, expressed as equivalent weight of phosphorous acid, of between 1.5 and 17 kg/ha and preferably between 2.5 and 10.5 kg/ha.

9. Method according to claim 8, characterized in that the compound A is, after harvesting the bananas resulting from a mother plant, applied in the section of the pseudostem of the mother plant, by injection or by pouring a treatment liquid comprising A, and/or applied in the pseudostem of the daughter plant, by injection.

10. Method according to claim 8 or 9, characterized in that the compound A is fosetyl-Al applied at a dose of between 2 and 25 kg/ha and preferably between 4 and 15 kg/ha.

11. Banana yield-enhancing composition comprising from 0.5 to 95% of compound A as defined in claim 1, in association with a vehicle which is acceptable in agriculture.
